(19) United States
(12) Patent Application Publication
(10) Pub. No.: US 2005/0190504 A1
(43) Pub. Date: Sep. 1, 2005

(54) Magnetic disk apparatus

(75) Inventors: Kei Funabashi, Kawasaki (JP); Hisashi Kaneko, Kawasaki (JP); Tsuneyori Ino, Kawasaki (JP); Yukihiro Komura, Kawasaki (JP); Mitsuhiro Izumi, Kawasaki (JP); Shinji Fujimoto, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED,, Kawasaki (JP)

(21) Appl. No.: 10/893,284

(22) Filed: Jul. 19, 2004

(30) Foreign Application Priority Data
Feb. 26, 2004 (JP) 2004-051973

(51) Int. Cl. G11B 5/54

(52) U.S. Cl. 360/256.2

(57) ABSTRACT

A magnetic disk apparatus includes an actuator including a magnetic head, a coil which forms a voice coil motor, and a coil arm which supports the coil, wherein the magnetic head can be rotated or swung by the voice coil motor so as to be positioned at any position on a magnetic disk, a magnet which forms the voice coil motor with the coil, and a latch mechanism for controlling the actuator so that the actuator is situated at a designated latch position in a non-operation condition. The latch mechanism is formed by the magnet and a magnetic metal piece provided to the coil arm, an extended part is formed at the magnetic metal piece, and the extended part is formed and positioned at a strong magnetic force generation part of the magnet when the actuator is positioned at the latch position.

### BACKGROUND OF THE INVENTION

1. Field of the Invention

The present invention relates to magnetic apparatuses, and more specifically, to a magnetic disk apparatus having a latch mechanism for controlling the movement of an actuator during the non-operating condition.

2. Description of the Related Art

A magnetic disk apparatus for recording and reproducing information to or from a magnetic disk must avoid wear which results from contact between a magnetic head (slider) and a magnetic disk surface. Therefore, a contact-start-stop (CSS) system is employed in which, during non-operation of the magnetic disk apparatus, the magnetic head is in contact with the disk surface, and during operation of the magnetic disk apparatus, namely, during recording or reproducing operations, the head floats above the rotating magnetic disk surface.

In the magnetic disk apparatus employing the CSS system, the head slider includes a magnetic head element to record or reproduce information to or from the magnetic disk which floats away from the rotating magnetic disk surface during operation of the disk drive by receiving air flow generated by rotation of the magnetic disk. When information is recorded or reproduced, the head slider moves while floating above the rotating magnetic disk surface and is then placed over a predetermined track of the magnetic disk.

On the other hand, when the magnetic disk apparatus is in the non-operating condition, the head slider is placed within the CSS zone provided on the magnetic disk surface. Moreover, when the magnetic disk apparatus is in the non-operating condition, since the disk is not rotating, air flow for floating the head slider is not generated and the head slider is in contact with the CSS zone.

Meanwhile, if the magnetic disk apparatus receives a shock when the head slider is in contact with the CSS zone, the head slider may move to the data zone and cause damage, namely, destruction of data or a disabling of the data reading or writing operation.

In recent years, with reduction of size, such a magnetic disk apparatus has been used in portable devices such as notebook-sized personal computers. Such a magnetic disk apparatus is often placed in a condition where it may easily receive an external shock. Therefore, high durability against shock is one of the performance characteristics required for the magnetic disk apparatus.

Therefore, a latch mechanism has been provided so that the actuator is fixed in the stop position (CSS zone) when the magnetic disk apparatus is in the non-operating condition. See Japanese Laid-Open Patent Application 2001-35103. By providing the latch mechanism, even if the magnetic disk apparatus receives a certain degree of shock, the head slider does not move to the data zone and thereby the magnetic disk and data can be protected.

FIG. 1 is a plan view of a related art magnetic disk apparatus 100 having a latch mechanism 150. FIG. 2 is an enlarged view of an actuator 122 provided in the magnetic disk apparatus 100.

As shown in FIG. 1 and FIG. 2, the actuator 122 supports a head slider 104 where the magnetic head is provided. The actuator 122 is engaged with a rotating or swinging shaft 135 and is adapted to freely swing, namely, the actuator 122 can rotate about the shaft 135. The head slider 104 is provided in front of the shaft 135 at the actuator 122, via a support arm 124 and a support spring 125.

Coil arms 152A and 152B are provided at rear part of the shaft 135 at the actuator 122. A voice coil 151 is mounted at the coil arms 152A and 152B. The voice coil 151 is placed within magnetic fields generated by an upper side magnet 54 provided at a lower surface of an upper side yoke (not shown), and a lower side magnet provided at an upper surface of a lower side yoke 153. A voice coil motor (VCM) 123 which rotates the actuator 122 includes the voice coil 151, the upper side yoke 152, the lower side yoke 153, the upper side magnet 154, and the lower side magnets 155, or the like.

Furthermore, a retract plate 126 formed by a magnetic metal is provided at a rear end part of the coil arm 152B of the actuator 122. In addition, a latch magnet 130 is provided at an external side position of the lower side yoke 153. The latch mechanism 150 includes the retract plate 126 and the latch magnet 130.

In this latch mechanism 150, when the head slider 104 stops in the CSS zone 131 of the magnetic disk 101 (the position of the actuator 122 at this time is called the non-operation position 122), the retract plate 126 approaches the latch magnet 130 and the magnetic force attracts the retract plate 126 toward the latch magnet 130.

As a result of this, when the actuator 122 is positioned at the non-operation position, the latch mechanism 150 prevents the actuator 122 from moving. Therefore, in a case where the head slide 104 receives a shock when it is in contact with the CSS zone 131, the head slider 104 is prevented from moving to a data zone 132 of the magnetic disk 101. Therefore, it is possible to prevent damage, namely, destruction of data or a disabling of the data reading or writing operation.

However, in the related art magnetic head apparatus 100, the latch mechanism 150 is formed by the retract plate 126 and the latch magnet 130 which is separated from the upper side magnet and lower side magnet 155 (hereinafter both the upper side magnet and the lower side magnet are together called the magnet 155). Therefore, a lot of parts are required for the latch mechanism 150. In addition, it is necessary to provide the latch magnet 130 at an external side position of the lower side magnet 155. Hence, this causes the structure in the vicinity of the voice coil motor 123 to be complex.

In order to solve this problem, it is being attempted to use the magnet 155 as the latch magnet. The actuator 122 is latched by using the magnet force of the magnet 155 and therefore it is possible to reduce the number of parts. Furthermore, since it is not necessary to provide the latch magnet 130 in the vicinity of the voice coil motor 123 separated from the magnet 155, it is possible to make the structure in the vicinity of the voice coil motor 123 simple.

Meanwhile, it is necessary to control the actuator 122 in the CSS zone 31 by using a strong torque in order to realize a latch mechanism 130 having high reliability. The positions where the strong magnetic forces are generated by the magnet 155 are corner positions which are surrounded by dotted lines and shown by arrows P1 and P2 in FIG. 1. The positions are called strong magnetic force generation positions.

However, in the latch position where the head slider 104 is positioned in the CSS zone 131, there is a large gap between the actuator 122 and the strong magnetic force generation positions P1 and P2. See FIG. 1. In a case where there is large gap between the actuator 122 and the strong magnetic force generation positions P1 and P2, the magnetic forces of the strong magnetic force generation positions P1 and P2 do not contribute to control of the actuator 122 and therefore it is not possible to securely latch the actuator 122.

In order to prevent this, it is necessary to place the actuator 122 close to the strong magnetic force generation positions P1 and P2. As a method for placing the actuator 122 close to the strong magnetic force generation positions P1 and P2, one idea is to make the coil arms 152A and 152B have wide configurations. For making the coil arms 152A and 152B have wide configurations, the coil arms 152A and 152B are positioned at the outside against extended lines (one-dot chain lines shown by marks A and B, respectively, in FIG. 1 and FIG. 2) of side surfaces 127A and 127B of the support arm 124 forming the actuator 122. See FIG. 2.

However, if the coil arms 152A and 152B have wide configurations, the weight of the actuator 122 increases so that the rotational inertia of the actuator 122 is made large. As a result of this, the load on the voice coil motor 123 is made large and therefore the acceleration of the actuator 122 is degraded and the consumption of electric power increases.

### SUMMARY OF THE INVENTION

Accordingly, it is a general object of the present invention to provide a novel and useful magnetic disk apparatus.

Another and more specific object of the present invention is to provide a magnetic disk apparatus having a simple structure and including a latch mechanism whereby an actuator can be securely latched.

The above object of the present invention is achieved by a magnetic disk apparatus, including an actuator including a magnetic head, a coil which forms a voice coil motor, and a coil arm which supports the coil, wherein the magnetic head can be rotated or swung by the voice coil motor so as to be positioned at any position on a magnetic disk;
a magnet which forms the voice coil motor with the coil; and
a latch mechanism for controlling the actuator so that the actuator is situated at a designated latch position in a non-operation condition,
wherein the latch mechanism is formed by the magnet and a magnetic metal piece provided to the coil arm,
an extended part is formed at the magnetic metal piece, and
the extended part is formed and positioned at a strong magnetic force generation part of the magnet when the actuator is positioned at the latch position.

According to the above-mentioned invention, the latch mechanism is formed by the magnet and the magnetic metal piece provided to the coil arm. Hence, the actuator is controlled to a designated latch position by attracting the magnetic metal piece based on the magnetic force of the magnet. In this case, even if the there is a gap between the latch position of the actuator and the strong magnetic force generation part of the magnet, since the extended part formed at the magnetic metal piece is formed and positioned at the strong magnetic force generation part of the magnet, it is possible to securely control (move) the actuator to the designated latch position.

The magnetic metal piece may have a cantilever structure where one end of the magnetic metal piece is fixed to the actuator and another end of the magnetic metal piece is a free end.

According to the above-mentioned invention, the magnetic metal piece whereof the extended part is formed has a simple structure, namely a cantilever structure. Hence, even if the magnetic metal piece having the extended part is provided to the actuator, it is possible to prevent the actuator from having a complex structure and from giving bad influence to an operation of the actuator.

The magnetic head may be in contact with the magnetic disk in the non-operation condition.

According to the above-mentioned invention, in the CSS type magnetic disk apparatus, it is possible to securely control the actuator to the latch position.

A side surface of the actuator including the coil arm may form a substantially straight line.

According to the above-mentioned invention, since the side surface of the actuator including the coil arm forms a substantially straight line, the width of the coil arm is made narrow so that it is possible to make the weight of the actuator light. Accordingly, the inertial force in the operation condition can be made small so that it is possible to increase the acceleration of the actuator.

Furthermore, since the side surface of the actuator including the coil arm form a substantially straight line, even if there is a gap between the latch position of the actuator and the strong magnetic force generation part of the magnet, it is possible to securely control the actuator to the latch position by forming the extended part of the magnetic metal piece toward the strong magnetic force generation part.

Other objects, features, and advantages of the present invention will become more apparent from the following detailed description when read in conjunction with the accompanying drawings.

### BRIEF DESCRIPTION OF THE DRAWINGS

FIG. 1 is a plan view of a related art magnetic disk apparatus;

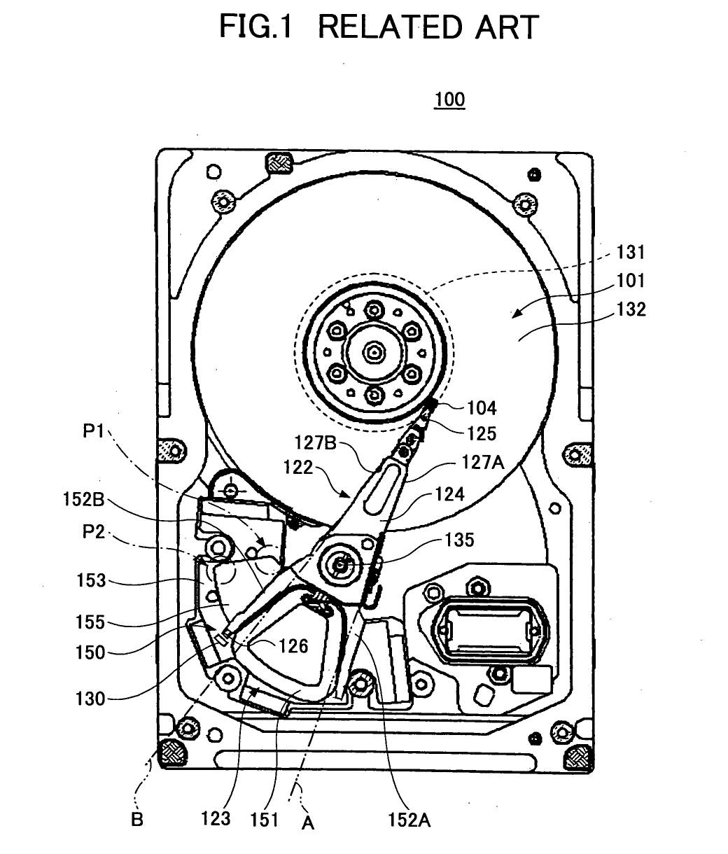

FIG. 2 is an enlarged view of an actuator provided in the magnetic disk apparatus shown in FIG. 1;

FIG. 3 is a plan view of a magnetic disk apparatus of an embodiment of the present invention;

FIG. 4 is an enlarged view of the vicinity of a latch mechanism of the magnetic disk apparatus of the embodiment of the present invention; and

FIG. 5 is an enlarged view of an actuator provided in the magnetic disk apparatus shown of the embodiment of the present invention.

### DETAILED DESCRIPTION OF THE PREFERED EMBODIMENTS

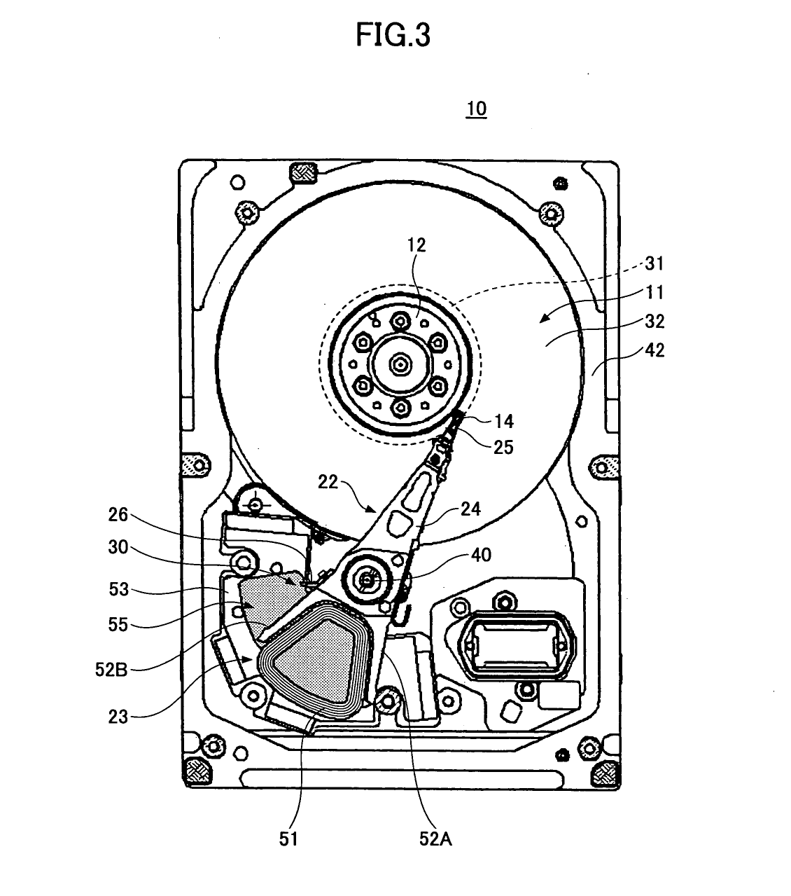

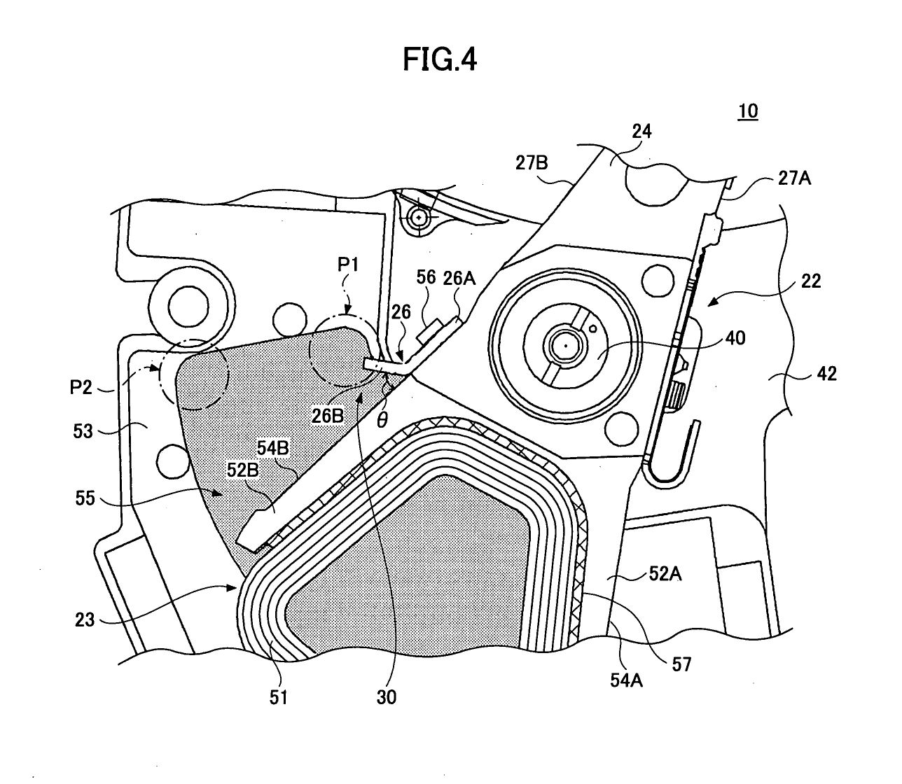

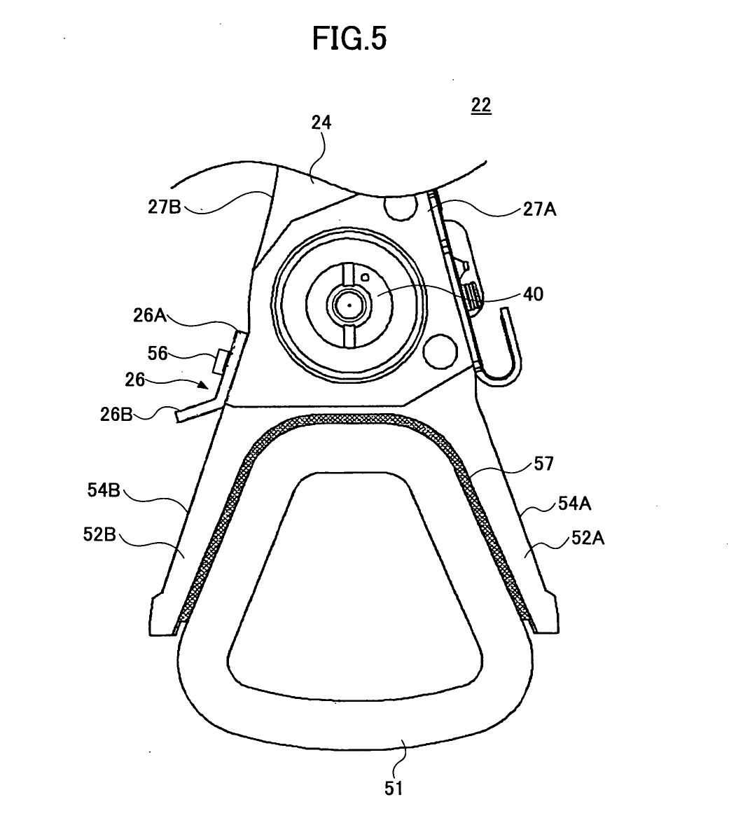

A description is given below, with reference to the FIG. 3 through FIG. 5, of embodiments of the present invention. FIG. 3 is a plan view of a magnetic disk apparatus 10 of the present invention. FIG. 4 is an enlarged view of the vicinity of a latch mechanism 150 of the magnetic disk apparatus 10 of the present invention. FIG. 5 is an enlarged view of an actuator 22 provided in the magnetic disk apparatus 10.

The magnetic disk apparatus 10 illustrated in FIG. 3 includes, within an enclosure consisting of a cover (not illustrated) and a base 42, a magnetic disk 11 as a data recording medium, a spindle motor 12 to drive the magnetic disk 11 to rotate, an actuator 22 on which a head slider 14 where a magnetic head is provided is mounted, and a voice coil motor (VCM) 23 to drive the actuator 22 to swing back and forth around an axis.

The magnetic disk 11 is fixed to a rotor part of the spindle motor 12. The magnetic disk 11 is driven to rotate by the spindle motor 12 during operation of the magnetic disk apparatus 10, namely, during recording or reproducing operations and is also driven to stop when the magnetic disk apparatus 10 is in a non-operating condition.

The magnetic disk apparatus 10 of this embodiment applies a Contact-Start-Stop (CSS) system. Therefore, during non-operation of the magnetic disk apparatus 10, the magnetic head is in contact with the magnetic disk 11. Hence, on the surface of the magnetic disk 11, a data zone 32 where the tracks on which data and servo information are recorded are arranged concentrically, and a stop area or CSS zone 31 in which the head slider 4 is placed when the disk drive is in the non-operating condition are provided. Here, the CSS zone 31 is provided at the internal circumference of the magnetic disk 11, but it may also be provided at the external circumference. The number of magnetic disks 11 to be mounted is not limited thereto and may be single or plural.

The actuator 22 is engaged with a shaft 40 standing on a base 42 and is adapted to freely swing, namely, the actuator 22 can rotate about the shaft 40. The actuator 22 has a support arm 24 and coil arms 52A and 52B. The shaft 40 is put between the support arm 24 and the coil arms 52A and 52B. A support spring 25 is provided at a head end part of the support arm 24. The support spring 25 gives a spring force to the head slider 14.

The head slider 14 faces the magnetic disk 11. The head slider has a head element (not shown) which records data from a control part (not shown) to a track of a surface of the magnetic disk, and reads out the data recorded at the track and sends it to the control part. When the magnetic disk apparatus 10 is in the non-operating condition, the head slider 14 is in contact with the CSS zone 31 situated at an inner area of the magnetic disk 11. When the magnetic disk apparatus 10 is in the operating condition, the head slider 14 floats away from the surface of the rotating magnetic disk 11.

A voice coil motor (VCM) 23 includes the voice coil 51 mounted at the coil arms 52A and 52B, the upper side yoke (not shown), the lower side yoke 53, the upper side magnet (not shown) provided at a lower surface of an upper side yoke, and the lower side magnets 55 provided at an upper surface of the lower side yoke 53, or the like. Hereinafter, unless otherwise noted, both the upper side yoke and the lower side yoke 53 are together called the yoke 53. Similarly, both the upper side magnet and the lower side magnet 55 are together called the magnet 55.

The driving electric current is supplied from a control part (not shown) to the voice coil 51. The voice coil 51 provided at the coil arms 52A and 52B is positioned between a pair of the magnets 55 provided at the yoke 53. Although the upper side magnet is provided at the upper side yoke and the lower side magnet 55 is provided the lower side yoke 53 in this embodiment, the magnet 55 may be provided at only one of the upper side yoke or the lower side yoke 53.

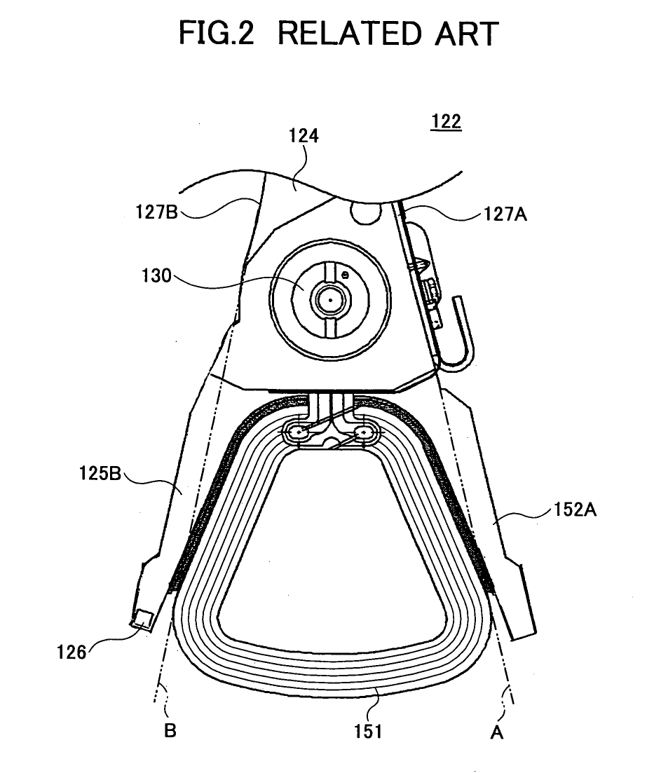

Meanwhile, in the actuator 22 of this embodiment, widths of the coil arms 52A and 52B are set to be narrower than the related art shown in FIG. 2. More specifically, since the widths of the coil arms 52A and 52B are narrow, a side surface 27A of the support arm 24 and a side surface 54A of the coil arm 52A form a substantially straight line, and a side surface 28B of the support arm 24 and a side surface 54B of the coil arm 52B form a substantially straight line, as shown in FIG. 5.

Thus, since the widths of the coil arms 52A and 52B are narrow, it is possible to make the actuator 22 have a light weight. Because of this, the inertial force of the actuator 22 in the operation condition is made small, so that it is possible to increase the acceleration of the actuator 22.

Next, the latch mechanism 30 is discussed.

In the latch mechanism 30 of this embodiment, a magnetic latch method wherein the actuator 22 is latched by the magnet force is applied and a magnet 55 is used as a latch magnet. Since the actuator 22 is latched by using the magnetic force of the magnet 55, it is possible to reduce the number of parts and make the structure in the vicinity of the voice coil motor 23 simple.

Furthermore, it is necessary to control the actuator 22 to the CSS zone 31 by using a strong torque in order to realize a latch mechanism 30 having high reliability. Therefore, in a structure of this embodiment wherein the actuator 22 is latched by using the magnet 55, it is efficient to latch by using strong magnetic force generation positions P1 and P2 where strong magnetic forces of corners of the magnet are generated. See FIG. 4.

However, in the magnetic disk apparatus 10 of this embodiment, the widths of the coil arms 52A and 52B are short in order to reduce the inertia. Because of this, there is a gap between the strong magnetic force generation positions P1 and P2 and actuator 22 in the non-operation condition of the actuator 22, namely in a condition where the head slider 14 is positioned at the CSS zone 31.

In this embodiment, a retract plate 26 is provided at the side surface of the actuator 22, more specifically at the side surface 54B of the coil arm 52B. That is, the latch mechanism 30 includes the retract plate 26 and the magnet 55.

The retract plate 26 is a magnetic metal piece. The retract plate 26 has a structure where the fixed part 26A and the extended part 26B are formed uniformly. The fixed part 26A is fixed to the coil arm 52B by a fixing screw 56 so that the retract plate 26 is installed on the actuator 22.

Furthermore, the extended part 26B extends from the fixed part 26A (the side surface 54B of the coil arm 52B) toward the strong magnetic generation position P1 obliquely. An extended angle θ and an extended length are set so that a head end part of the extended part 26B is positioned in the strong magnetic force generation position P1 when the actuator 22 is positioned at a designated latch position.

Because of this, the retract plate 26 (the extended part 26B) is attracted by a strong magnetic force generated by the strong magnetic force generation position P1 of the magnet 55 and therefore the actuator 22 is controlled (latched) to the designated latch position by the magnetic attraction force. Thus, in this embodiment, since the latch mechanism 30 is formed by the magnet 55 and the retract plate 26, it is possible to simplify the latch mechanism 30 and make the latch mechanism 30 have a light weight. Furthermore, even if the actuator 22 is made to have a light weight, it is possible to securely control the actuator 22 to the designated latch position.

In addition, the retract plate 26 has a cantilever structure where the extended part 26B whose head end part is a free end is extended from the fixed part 26A. Therefore, it is possible to simplify the structure of the latch mechanism 30 by this. Furthermore, since the retract plate 26 is a metal piece and has a simple structure, namely the cantilever structure, even if the retract plate 26 is provided at the actuator 22, it is possible to prevent the structure of the actuator 22 from being complicated and the actuator 22 from having a bad influence.

Furthermore, in the retract plate 26 having a cantilever structure, it is possible to easily and optionally set the extended angle θ and the extended length against the coil arm 52B. Therefore, it is possible to securely position the head end part of the retract plate 26 at the strong magnetic force generation position P1. Accordingly, the latch mechanism 30 of this embodiment can be widely applied to various standard and various disk-size magnetic disk apparatuses 10.

The present invention is not limited to these embodiments, but variations and modifications may be made without departing from the scope of the present invention.

This patent application is based on Japanese Priority Patent Application No. 2004-51973 filed on Feb. 26, 2004, and the entire contents of which are hereby incorporated by reference.

1. A magnetic disk apparatus, comprising:
an actuator including a magnetic head, a coil which forms a voice coil motor, and a coil arm which supports the coil, wherein the magnetic head can be rotated or swung by the voice coil motor so as to be positioned at any position on a magnetic disk;
a magnet which forms the voice coil motor with the coil; and
a latch mechanism for controlling the actuator so that the actuator is situated at a designated latch position in a non-operation condition,
wherein the latch mechanism is formed by the magnet and a magnetic metal piece provided to the coil arm,
an extended part is formed at the magnetic metal piece, and
the extended part is formed and positioned at a strong magnetic force generation part of the magnet when the actuator is positioned at the latch position.

2. The magnetic disk apparatus as claimed in claim 1,
wherein the magnetic metal piece has a cantilever structure where one end of the magnetic metal piece is fixed to the actuator and another end of the magnetic metal piece is a free end.

3. The magnetic disk apparatus as claimed in claim 1,
wherein the magnetic head is in contact with the magnetic disk in the non-operation condition.

4. The magnetic disk apparatus as claimed in claim 2,
wherein the magnetic head is in contact with the magnetic disk in the non-operation condition.

5. The magnetic disk apparatus as claimed in claim 1,
wherein a side surface of the actuator including the coil arm form a substantially straight line.

6. The magnetic disk apparatus as claimed in claim 2,
wherein a side surface of the actuator including the coil arm form a substantially straight line.

7. The magnetic disk apparatus as claimed in claim 3,
wherein a side surface of the actuator including the coil arm form a substantially straight line.

8. The magnetic disk apparatus as claimed in claim 4,
wherein a side surface of the actuator including the coil arm form a substantially one straight line.
